(19) United States
(12) Patent Application Publication
(10) Pub. No.: US 2011/0214523 A1
(43) Pub. Date: Sep. 8, 2011

(54) MARINE GEAR SELECTION AND TRIM CONTROL

(76) Inventor: Michael Alan Beachy Head, Cape Town (ZA)

(21) Appl. No.: 13/063,424

(22) PCT Filed: Sep. 14, 2009
(86) PCT No.: PCT/IB09/54008

§ 371 Date: May 27, 2011

(30) Foreign Application Priority Data
Sep. 16, 2008 (GB) 0816968.2

(51) Int. Cl. F16H 59/00

(52) U.S. Cl. 74/473.11

(57) ABSTRACT

A system is operated by a method to provide hydraulic fluid for gear selection and trim in a marine drive by supplying hydraulic pressure to a trim actuator- when trim is required and diverting hydraulic fluid to an accumulator, when trim is not required and hydraulic pressure in the accumulator drops below a predetermined pressure. The hydraulic fluid is directed to the accumulator to maintain hydraulic pressure in the accumulator within predetermined limits and is directed from the accumulator to a gear selection actuator, when gear selection is required.

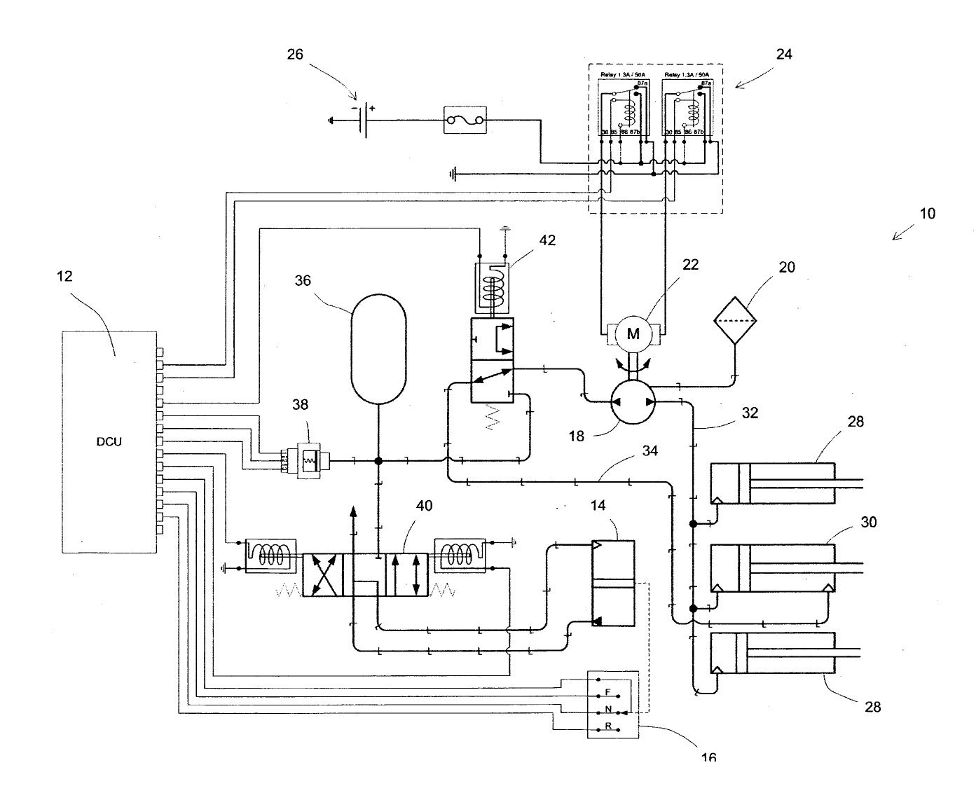

### CROSS REFERENCE TO RELATED APPLICATIONS

This application is a United States national phase of co-pending international patent application No. PCT/IB2009/054008, filed Sep. 14, 2009, which claims priority to Great Britain application No. GB0816968.2, filed Sep. 16, 2008, the disclosures of which are incorporated herein by reference.

### FIELD OF THE INVENTION

This invention relates to mechanisms for hydraulic gear selection and trim control in marine vessels.

### BACKGROUND TO THE INVENTION

The transmissions of most marine vessels include gear selectors that can shift to engage reverse or forward gears, typically with a neutral position between them. These transmissions normally use dog, cone or multi-plate clutches coupled to a gear selector system in order to change gears. For dog and cone clutches, mechanical links and mechanisms are used for gear selection while hydraulic gear selector actuators are commonly used for multi-plate clutches. A hydraulic gear selector actuator (typically a bi-directional piston arrangement) requires a continuous supply of hydraulic pressure during times of engagement in either the forward or reverse direction. In the neutral position hydraulic pressure is removed from both sides of the piston and the clutch is thus disengaged.

In hydraulic gear selector systems a supply of fluid at the required pressure is typically provided from a dedicated hydraulic pump that supplies pressurised hydraulic fluid to the gearshift actuator. The drives of marine vessels that are capable of being trimmed and/or tilted also require hydraulic pressure. In a typical marine drive, a dedicated hydraulic pump would supply hydraulic fluid to actuators (typically hydraulic pistons) The direction of operation of the actuators is controlled by controlling the rotational direction of the pump.

The present invention seeks to provide hydraulic gear selection system for a marine transmission with a cone clutch with hydraulic fluid, when required, at the required pressures for gear selection and trim, in a compact manner.

### SUMMARY OF THE INVENTION

According to one aspect of the present invention there is provided a method of providing hydraulic fluid for gear selection and trim in a marine drive, said method comprising:

providing a supply of hydraulic pressure for at least one trim actuator;

directing hydraulic fluid from the supply to the trim actuator to trim the marine drive, when trim is required;

directing hydraulic fluid from the supply to an accumulator when trim is not required and hydraulic pressure in the accumulator drops below a predetermined pressure;

controlling the direction of hydraulic fluid to the accumulator to maintain hydraulic pressure in the accumulator within predetermined limits; and

directing hydraulic fluid from the accumulator to a gear selection actuator, when gear selection is required.

The method may include controlling the position of the gear selector actuator through a directional control valve and with position feedback from a position sensor.

The method may include controlling the pressure at which hydraulic fluid is provided from the accumulator to the gear selector actuator when neutral is required, in such a way that the gear selector actuator is established in the neutral position.

The method may also include controlling the supply of hydraulic fluid to the trim actuator by varying the speed of a motor driving a hydraulic pump of the supply of hydraulic fluid.

According to another aspect of the present invention there is provided a marine gear selection and trim system comprising:

a supply of hydraulic fluid under pressure;

at least one trim actuator, connectable to the hydraulic fluid supply;

a hydraulic accumulator, connectable to the hydraulic fluid supply;

a valve connecting the hydraulic fluid supply to the trim actuator or to the accumulator;

a bi-directional gear selection actuator, connectable to the accumulator;

a sensor configured to measure hydraulic pressure inside the accumulator; and

a controller, wherein said controller is configured to operate the valve to connect the hydraulic fluid supply to the trim actuator during normal operation and to connect the hydraulic fluid supply to the accumulator, when the hydraulic pressure in the accumulator drops below a predetermined pressure and the trim actuator is inactive.

The system may further include a second valve, configured to control the direction of fluid from the accumulator to the gear selector actuator and a sensor, configured to sense the position of the gear selector actuator and to provide feedback to the controller, which uses the feedback to control the operation of the second valve to establish the actuator in forward, reverse and neutral positions.

The hydraulic fluid supply may include a pump driven by an electric motor, to control supply of hydraulic fluid to the trim actuator by controlling pump rotation.

### BRIEF DESCRIPTION OF THE DRAWINGS

For a better understanding of the present invention, and to show how the same may be carried into effect, the invention will now be described by way of non-limiting example, with reference to the accompanying drawing which shows a schematic diagram of a marine gear selection and trim system in accordance with the present invention.

### DETAILED DESCRIPTION

Referring to the drawing, a marine gear selection and trim system in accordance with the present invention is generally indicated by reference numeral 10.

The system 10 includes a controller in the form of a drive control unit (DCU) 12 that receives input from the helm of the marine vessel on which the system is installed. The DCU 12 can receive a variety of inputs from the helm, but the inputs include commands to trim a drive of the vessel up or down and commands to change the gear selection of the drive.

The system 10 includes a gear selection actuator 14 in the form of a double acting hydraulic piston, connected to a selector rod to a cone clutch of the drive. Actuation of the piston of the actuator 14 changes gears of the drive by shifting a clutch between opposing positions in which forward and reverse gears are engaged, respectively, or holding the clutch in a neutral position between the engagement of forward and reverse gears. The gear selection actuator 14 is provided with gearshift sensor 16 that is disposed to monitor the position of the actuator 14 and to send signals to the DCU relating to engagement of forward, neutral or reverse gears by the actuator. When in either forward or reverse, the piston is returned to its neutral position when the DCU is given the command by applying pressure on the opposing side of the piston until the DCU senses the neutral position by means of sensor 16.

The system 10 includes a supply of hydraulic fluid under pressure. In particular, the supply includes a hydraulic pump 18 connected to a hydraulic reservoir 20 (which can be a common reservoir with a hydraulic steering system of the marine drive). The pump 18 is driven by a variable speed electric motor 22, which receives electrical power from a relay bridge, generally indicated by reference numeral 24. The relay bridge 24 is controlled by the DCU 12 to provide power from a battery 26 of the power supply to the motor 22, as described below.

The system 10 includes at least one trim actuator, preferably two trim actuators in the form of single acting hydraulic trim cylinders 28 and one trim actuator in the form of a double acting hydraulic tilt cylinder 30. A hydraulic lift line 32 is connected to a working side of each of the trim cylinders 28 and the tilt cylinder 30, for trimming the drive up and a hydraulic lower line 34 is connected to an opposing working side of the tilt cylinder for trimming the drive down.

During normal operation of the system 10, the DCU 12 controls the direction of rotation of the motor 22 via the relay bridge 24, to supply hydraulic fluid under pressure to the trim and tilt cylinders 28,30 via the lift line 32 or lower line 34, according to the trim commands the DCU receives from the helm.

The system 10 further includes a hydraulic accumulator 36, with an accumulator pressure sensor 38 disposed on a supply of the accumulator, to measure the pressure in the accumulator. The accumulator 36 is connected to the gear selection actuator 14 via a bi-directional solenoid valve 40 that is normally in a closed position, in which hydraulic fluid from the accumulator is not directed to the valve 40. The valve 40 can be actuated by the DCU 12 to supply hydraulic fluid to either working side of the gear selection actuator 14, to change gears between neutral, forward and reverse, with feedback on the position of the actuator 14 provided to the DCU from the gearshift sensor 16.

When the hydraulic pressure in the accumulator 36 drops below a predetermined pressure, a low pressure signal is transmitted from the pressure sensor 38 to the DCU 12. If the trim actuators 28,30 are not active and the pressure in the accumulator 36 is low, the DCU 12 activates an accumulator charge solenoid valve 42, which disconnects the lower line 34 from the pump 18 and instead connects the supply of the accumulator to the pump. The pump 18 is activated under control of the DCU 12 to pump hydraulic fluid to charge the accumulator 36 until the pressure sensor 38 signals the DCU that the accumulator pressure has reached a predetermined upper lever and the DCU deactivates the valve 42 to return the system to its normal operating condition.

For safety reasons, the DCU 12 is configured to give precedence to pressurising the accumulator 36 if the pressure in the accumulator is too low to activate the gear selection actuator. This is to ensure that the accumulator 36 always holds sufficient hydraulic pressure to allow the marine drive to be shifted from forward or reverse gears, to neutral. Under other conditions (i.e. when there is enough pressure in the accumulator 36 for at least one change of gear), the DCU 12 gives precedence to providing hydraulic pressure from the pump 18 to the trim actuators 28,30 and provides pressure to charge the accumulator 36 only when the trim actuators 28,30 are idle.

The pump 18, motor 22, accumulator 36, sensor 38 and valves 40,42 are packaged together on a manifold casing to form an integrated power pack assembly, that is substantially more compact than the combined size of the separate power packs for gear selection and trim on prior art marine drives.

1. A method of providing hydraulic fluid for gear selection and trim in a marine drive, said method comprising:
providing a supply of hydraulic pressure for at least one trim actuator;
directing hydraulic fluid from the supply to the trim actuator to trim the marine drive, when trim is required;
directing hydraulic fluid from the supply to an accumulator when trim is not required and hydraulic pressure in the accumulator drops below a predetermined pressure;
controlling the direction of hydraulic fluid to the accumulator to maintain hydraulic pressure in the accumulator within predetermined limits; and
directing hydraulic fluid from the accumulator to a gear selection actuator, when gear selection is required.

2. A method as claimed in claim 1, further comprising controlling the position of the gear selector actuator through a directional control valve and with position feedback from a position sensor.

3. A method as claimed in claim 1, further comprising controlling the pressure at which hydraulic fluid is provided from the accumulator to the gear selector actuator when neutral is required, in such a way that the gear selector actuator is established in the neutral position.

4. A marine gear selection and trim system comprising:
a supply of hydraulic fluid under pressure;
at least one trim actuator, connectable to the hydraulic fluid supply;
a hydraulic accumulator, connectable to the hydraulic fluid supply;
a valve connecting the hydraulic fluid supply to the trim actuator or to the accumulator;
a gear selection actuator, connectable to the accumulator;
a sensor configured to measure hydraulic pressure inside the accumulator; and
a controller, wherein said controller is configured to operate the valve to connect the hydraulic fluid supply to the trim actuator during normal operation and to connect the hydraulic fluid supply to the accumulator, when the hydraulic pressure in the accumulator drops below a predetermined pressure and the trim actuator is inactive.

5. A system as claimed in claim 4, wherein aid system includes a second valve configured to control the direction of fluid from the accumulator to the gear selector actuator, and a sensor configured to sense the position of the gear selector actuator and to provide feedback to the controller.

6. A method as claimed in claim 2 further comprising controlling the pressure at which hydraulic fluid is provided from the accumulator to the gear selector actuator when neutral is required, in such a way that the gear selector actuator is established in the neutral position.
